(19) United States
(12) Patent Application Publication
(10) Pub. No.: US 2005/0078092 A1
(43) Pub. Date: Apr. 14, 2005

(54) Whiteboard desk projection display

(76) Inventor: Edward O. Clapper, Tempe, AZ (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/682,136

(22) Filed: Oct. 8, 2003

(51) Int. Cl. G09G 5/00

(52) U.S. Cl. 345/173

(57) ABSTRACT

Collaborative work on an interactive system is facilitated by accurately capturing and displaying information on an interactive system, wherein multiple users may work together for supplying and receiving information on a common writing surface. A whiteboard device is provided to project an image on desk surface. The present invention enables each user to have at least two display areas to work on.

### BACKGROUND INFORMATION

In collaborative working environments, several users may wish to view and manipulate displayed information simultaneously. It is desirable to provide a computer controlled electronic display system that allows for more space. Each of the multiple users would manipulate an input device which could be used simultaneously and independently for controlling its related pointer on the display in order to position a cursor, select an item from a menu, draw upon the display screen, or perform any number of standard functions. In this way the actions of each user would be readily visible to all the members of the group, who would interact together much as they would relative to a conventional chalkboard or whiteboard.

Computer systems generally incorporate a display unit for providing a visual indication to the users of selected data. However, current solutions do not offer a natural means on the desktop for users to collaborate their ideas. Therefore a need exists where users can increase screen real estate by using their desktop to show whiteboard content.

### BRIEF DESCRIPTION OF THE DRAWINGS

Various features of the invention will be apparent from the following description of preferred embodiments as illustrated in the accompanying drawings, in which like reference numerals generally refer to the same parts throughout the drawings. The drawings are not necessarily to scale, the emphasis instead being placed upon illustrating the principles of the inventions.

FIG. 1 is a perspective view of a whiteboard desk projection display.

### DETAILED DESCRIPTION

In the following description, for purposes of explanation and not limitation, specific details are set forth such as particular structures, architectures, interfaces, techniques, etc. in order to provide a thorough understanding of the various aspects of the invention. However, it will be apparent to those skilled in the art having the benefit of the present disclosure that the various aspects of the invention may be practiced in other examples that depart from these specific details. In certain instances, descriptions of well-known devices, circuits, and methods are omitted so as not to obscure the description of the present invention with unnecessary detail.

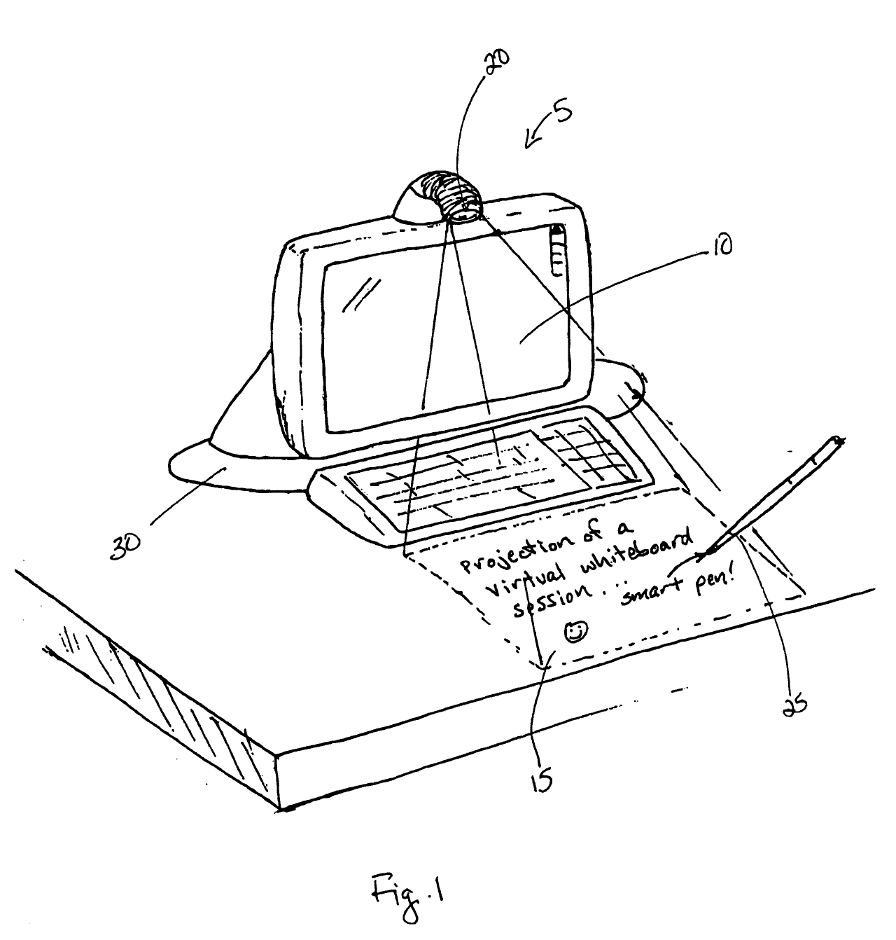

Referring to FIG. 1, the present invention is an integrated whiteboard projection assembly 5 that uses a monitor display 10 and a desktop display 15 as a foundational reference for projecting a reliable virtual whiteboard and providing a means for collaborators at disparate desktop machines to interact naturally by “drawing” on their respective desk's projected display region 15. The assembly 5 may employ an integrated short-range projection device 20, an active stylus 25 and the desktop display 15 to provide a desk-based interactive whiteboard experience.

The integrated whiteboard desk projection display may also be considered a dual monitor system where the projection device 20 is a monitor and the display is a monitor. The integrated whiteboard desk device 5 may project something different on the desk surface 15 then is displayed on the monitor display screen 10. Thus you have two different display images 10, 15 that are being displayed at one time. Furthermore, the assembly 5 may become one system when integrated into a single PC with a monitor and projection device all integrated into a single housing.

The projection device 20, preferably, can be a low-medium-resolution, low powered projector which may be mounted on top of a user's monitor display 10. However, the projector does not necessarily have to be low-medium-resolution or low powered, it can be any type of projector. The projection device 20 may be part of the monitor display 10 itself. However, the projection device 20 does not necessarily have to be integrated to the display 10. The projector device 20 may be a separate attachment that can attach to an existing monitor. The projection device 20 can take on many forms and its angle and orientation should be adjustable as well as the size and focus.

The projection device 20 may project a “white rectangle” on the user's desk, the desktop display 15, and this region may be calibrated for location and “keystone” shape using the active stylus 25. The stylus device 25, which is a well-known inkless device in the art, is used to write on the desk surface 15. Its motion is tracked either by a stylus pad (where the whiteboard is projected) or by location sensing electronics in the projector 20 or display 10. The stylus 25 motion is translated into pen strokes, which are rendered in color on the projected desktop display 15. Colors can be changed, and the stylus 25 can erase any content in real-time. Each collaborator may be able to view any strokes made by any other user on the desk display 15. The projected desk display 15 may be projected on a variety of surfaces, however, for design purposes a lighter surface would be best.

A user's ability to select color for drawings with the stylus 25 can be displayed on the monitor 10. The stylus 25 communicates with the PC and senses what the stylus 25 is touching. The stylus 25 can either be used to trigger a touch screen on the monitor 10 or it can actually transmit its position from a region within the projected surface area 15. Any controls related to the whiteboard can be located either on the monitor display 10 or on the projected region 15. This is because the stylus 25 is being used to identify the position of the projected region 15, otherwise the stylus 25 would not be able to write on the desk region 15. A display base 30 may create the coordinate system for the stylus 25. A sensor mechanism (not shown) which may allow the pen position to be detected may be built into the base of the display. Since the sensor mechanism may be located within the base 30, there is a relation between the position of the base 30 and the position of the projection device 20. Most system may perform a calibration test to reconcile this.

Most PCs have multiple video channels. For the current system the PC may use both video out channels. The monitor display 10 may use one and the projection device 20 may use the other. The video feed of the projector 20 is independent of the user's monitor video signal and can be a secondary video channel from the same PC. A whiteboard interface (not shown), which is well know in the art, may be dedicated to the projection channel, and can be shared in the same manner as similar interfaces in existing tools such as NetMeeing and Webex. In fact, these interfaces may be adapted to use the assembly 5 directly. If the projection device 20 is not integrated to the monitor 10, and rather is an add on peripheral, it would connect to the secondary video channel and the software would direct all the whiteboard activity through that port.

For example, suppose several collaborators all over the world are engaged in a Netmeeting in their respective offices. As the material is very dynamic, the whiteboard is an ideal solution. By engaging the desktop whiteboard, each contributor can now see the whiteboard projected on their desk. Adding whiteboard contributions is as simple as drawing in the projected area on each person's desk with a stylus. Virtual ink allows sketching to be rendered in real time on the projected view, enabling collaborators to easily draw complex diagrams interactively.

Some embodiments of the invention provide advantages in that the whiteboard desk projection display is a great short funnel option for PCs. Immediate return may be realized by eliminating unnecessary business trips. Costs of the whiteboard desk projection display may be kept low by employing low-resolution projection components.

Advantageously, the present concept increases useful screen real estate, since it uses the desktop to show the whiteboard content. This allows the user to continue using their desktop screen for additional work space. The device can also be used at the user's desk, and meetings can move very naturally into whiteboard space. In addition, other content can be projected onto the desk, and each user can contribute sketch-over input directly on the presentation content.

The foregoing and other aspects of the invention are achieved individually and in combination. The invention should not be construed as requiring two or more of such aspects unless expressly required by a particular claim. Moreover, while the invention has been described in connection with what is presently considered to be the preferred examples, it is to be understood that the invention is not limited to the disclosed examples, but on the contrary, is intended to cover various modifications and equivalent arrangements included within the spirit and the scope of the invention.

1. A whiteboard desk display, comprising:
a monitor;
a whiteboard projector device couple to the monitor for projecting an image on a desk surface;
a stylus to communicate with the projected image on the desk surface; and
a sensor apparatus to track motion of the stylus on the projected desk image.

2. The whiteboard display of claim 1, wherein the desk surface is a whiteboard shared my multiple users.

3. The whiteboard display of claim 2, wherein the users have at least two display surfaces.

4. The whiteboard display of claim 1, wherein the whiteboard device communicates to said monitor through a video port.

5. The whiteboard display of claim 1, wherein the whiteboard device is adjustable.

6. The whiteboard display of claim 1, wherein the whiteboard projector device is located on top of the monitor.

7. The whiteboard display of claim 1, wherein motion of the stylus is tracked in real time by the users.

8. An integrated whiteboard assembly, comprising:
a computer;
a monitor coupled to the computer; and
a projection device coupled to the monitor,
wherein the projection device projects an image on a surface where multiple users may share the image.

9. The integrated whiteboard assembly of claim 8, wherein the surface is a desk surface.

10. The integrated whiteboard assembly of claim 8, further comprising a stylus for communicating with the users.

11. The integrated whiteboard assembly of claim 10, further comprising a position sensing means for sensing the position of the stylus.

12. The integrated whiteboard assembly of claim 8, wherein the projection device communicates to the computer through a video port.

13. The integrated whiteboard assembly of claim 11, wherein the motion of the stylus is tracked in real time by the users.

14. The integrated whiteboard assembly of claim 8, wherein the projection device is adjustable.

15. The integrated whiteboard assembly of claim 9, wherein the projected image is a whiteboard image shared my multiple users.

16. The integrated whiteboard assembly of claim 8, wherein each user has at least two display screens.

17. The integrated whiteboard assembly of claim 8, wherein the projection device is located on top of the monitor.
